(19) United States
(12) Patent Application Publication
(10) Pub. No.: US 2021/0312403 A1
(43) Pub. Date: Oct. 7, 2021

(54) IDENTIFYING ATTENDEE AVAILABILITY AND CURRENT LOCATION, AND SCHEDULING A MEETING IN THE NEAREST AVAILABLE CONFERENCE ROOM

(71) Applicant: Carrier Corporation, Palm Beach Gardens, FL (US)

(72) Inventors: Nagavendra Chappa, Angul, Orissa (IN); Bhabani Sankar Nanda, Hyderabad, Telangana (IN); Adam Kuenzi, Silverton, OR (US); Vijayaraghavan Chari, Hyderabad, Telangana (IN); Kameswari Elindra, Hyderabad, Telangana (IN)

(21) Appl. No.: 17/058,146

(22) PCT Filed: Oct. 25, 2019
(86) PCT No.: PCT/US2019/057986

§ 371 Date: Nov. 24, 2020

(30) Foreign Application Priority Data
Oct. 27, 2018 (IN) 201811040582

(51) Int. Cl. G06Q 10/10; G06Q 10/02

(52) U.S. Cl. CPC G06Q 10/1095; G06Q 10/02

(57) ABSTRACT

A method of selecting meeting locations includes receiving a request to schedule a meeting, the request including requested meeting attendees. A current physical location of at least a subset of the requested meeting attendees is received. Time slots that the requested meeting attendees are available for the meeting are identified. A meeting location for the meeting is selected at a time slot included in the identified time slots. The selecting is based at least in part on availability of the meeting location during the time slot and a proximity of the selected meeting location to the at least a subset of the meeting attendees.

### CROSS REFERENCE TO RELATED APPLICATIONS

This application claims the benefit of IN Application No. 201811040582, filed on Oct. 27, 2018, which is incorporated herein by reference in its entirety.

### BACKGROUND

The subject matter disclosed herein generally relates to the field of scheduling systems, and more particularly to an apparatus and method for identifying attendee availability and current position based on indoor positioning technology, and for scheduling a meeting in the nearest available conference room based on attendee current position.

When scheduling a meeting on short notice, it can be difficult to find a meeting location that is available and convenient for the meeting attendees. A meeting coordinator, or requestor, may attempt to find the physical locations of the other attendee(s) and their available time slots. Determining this information requires the meeting coordinator to ask each of the attendees about their availability during particular time slots and about where they are currently located or plan to be located at times close to the time slots. If the meeting coordinator is successful in obtaining this information, the meeting coordinator is then required to know which of the available conference rooms are closest to one or more of the attendees. The meeting coordinator then has to check these conference rooms to determine availability during the time slots that the attendees are available.

### BRIEF SUMMARY

According to an embodiment, a method of selecting meeting locations is provided. The method includes receiving a request to schedule a meeting, the request including requested meeting attendees. A current physical location of at least a subset of the requested meeting attendees is received. Time slots that the requested meeting attendees are available for the meeting are identified. A meeting location for the meeting is selected at a time slot included in the identified time slots. The selecting is based at least in part on availability of the meeting location during the time slot and a proximity of the selected meeting location to the at least a subset of the meeting attendees.

In addition to one or more of the features described above or below, or as an alternative, further embodiments of the method may include that the selecting including reserving the meeting location for the meeting during the time slot.

In addition to one or more of the features described above or below, or as an alternative, further embodiments of the method may include that the selecting further including notifying the requested meeting attendees of the meeting location and the time slot.

In addition to one or more of the features described above or below, or as an alternative, further embodiments of the method may include that a time of the notifying takes into account a travel time to the meeting location.

In addition to one or more of the features described above or below, or as an alternative, further embodiments of the method may include based at least in part on the selecting, changing an environmental set point of the meeting location during the time slot.

In addition to one or more of the features described above or below, or as an alternative, further embodiments of the method may include that the environmental set point includes at least one of a temperature at the meeting location and lighting at the meeting location.

In addition to one or more of the features described above or below, or as an alternative, further embodiments of the method may include based at least in part on the selecting, transmitting a mobile credential to at least one of the requested meeting attendees, the mobile credential configured to unlock, during the time slot, an access control device that controls access to the meeting location.

In addition to one or more of the features described above or below, or as an alternative, further embodiments of the method may include based on the selecting, transmitting to each of the at least a subset of the requested meeting attendees directions from their current physical locations to the selected meeting location.

In addition to one or more of the features described above or below, or as an alternative, further embodiments of the method may include that the current physical location of at least a subset of the requested meeting attendees is determined based at least in part on indoor positioning techniques.

In addition to one or more of the features described above or below, or as an alternative, further embodiments of the method may include that the current physical location of at least a subset of the requested meeting attendees is a physical location within a building.

In addition to one or more of the features described above or below, or as an alternative, further embodiments of the method may include that the time slot is within a threshold amount of time of receiving the request.

According to another embodiment, a system of selecting meeting locations is provided. The system includes a processor and a memory. The memory includes computer-executable instructions that, when executed by the processor, cause the processor to perform operations. The operations include receiving a request to schedule a meeting, the request including requested meeting attendees. A current physical location of at least a subset of the requested meeting attendees is received. Time slots that the requested meeting attendees are available for the meeting are identified. A meeting location for the meeting is selected at a time slot included in the identified time slots. The selecting is based at least in part on availability of the meeting location during the time slot and a proximity of the selected meeting location to the at least a subset of the meeting attendees.

In addition to one or more of the features described above or below, or as an alternative, further embodiments of the system may include that the selecting including reserving the meeting location for the meeting during the time slot.

In addition to one or more of the features described above or below, or as an alternative, further embodiments of the system may include that the selecting further including notifying the requested meeting attendees of the meeting location and the time slot.

In addition to one or more of the features described above or below, or as an alternative, further embodiments of the system may include based at least in part on the selecting, changing an environmental set point of the meeting location during the time slot.

In addition to one or more of the features described above or below, or as an alternative, further embodiments of the system may include that the environmental set point includes at least one of a temperature at the meeting location and lighting at the meeting location.

In addition to one or more of the features described above or below, or as an alternative, further embodiments of the system may include based at least in part on the selecting, transmitting a mobile credential to at least one of the requested meeting attendees, the mobile credential configured to unlock, during the time slot, an access control device that controls access to the meeting location.

In addition to one or more of the features described above or below, or as an alternative, further embodiments of the system may include based on the selecting, transmitting to each of the at least a subset of the requested meeting attendees directions from their current physical locations to the selected meeting location.

In addition to one or more of the features described above or below, or as an alternative, further embodiments of the system may include that the current physical location of at least a subset of the requested meeting attendees is determined based at least in part on indoor positioning techniques.

In addition to one or more of the features described above or below, or as an alternative, further embodiments of the system may include that the time slot is within a threshold amount of time of receiving the request.

Technical effects of embodiments of the present disclosure include an easy way for a meeting requestor to search availability of other users before scheduling a meeting, which can improve the probability of the other users attending the meeting. Technical effects of embodiments of the present disclosure also include the ability to identify the nearest available conference room for the attendees based on their current physical location. Technical effects of embodiments of the present disclosure further include providing the requested meeting attendees (including the meeting host or requestor) with a route from their current location to the conference room where the meeting is being held.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

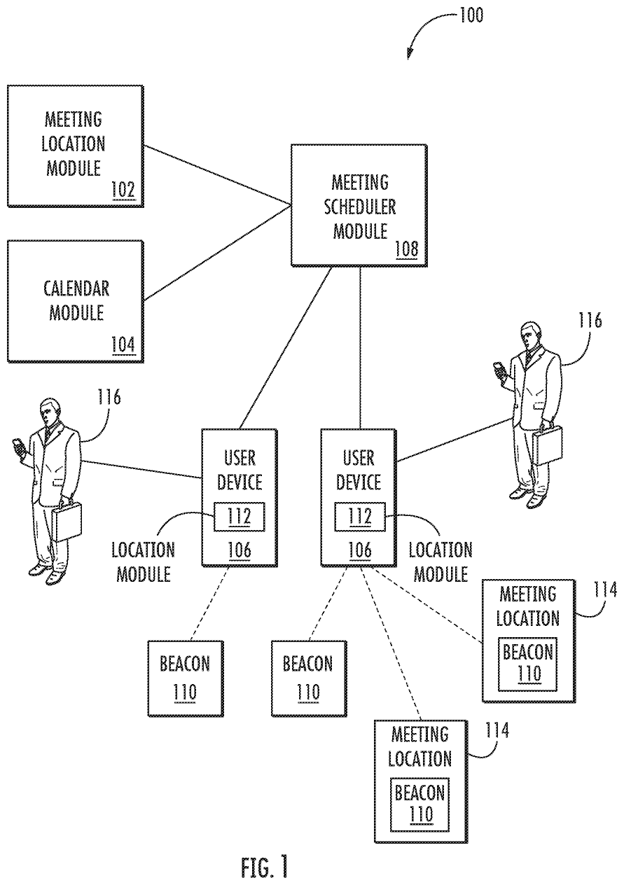

FIG. 1 illustrates a schematic diagram of selecting meeting locations, in accordance with an embodiment of the disclosure; and

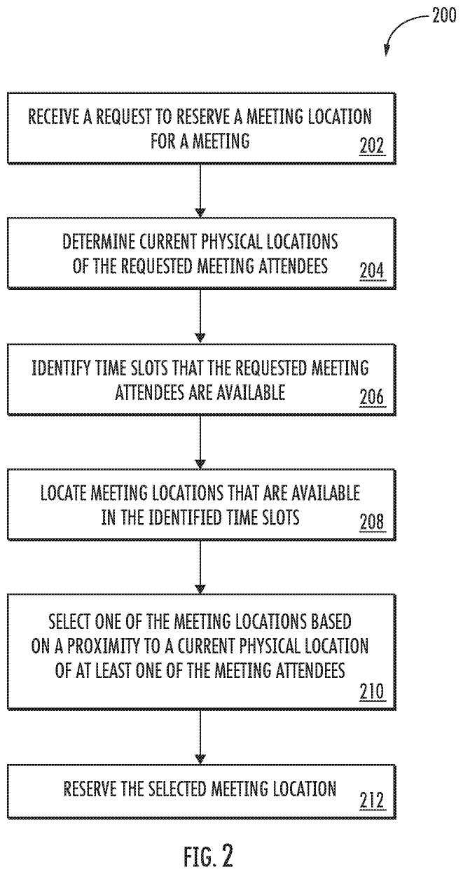

FIG. 2 is a flow diagram illustrating a method of selecting meeting locations, in accordance with an embodiment of the disclosure.

### DETAILED DESCRIPTION

A detailed description of one or more embodiments of the disclosed apparatus and method are presented herein by way of exemplification and not limitation with reference to the Figures.

One or more embodiments of the present invention provide a system and method for selecting meeting locations. In accordance with one or more embodiments of the present invention, attendee availability and current position are identified based on indoor positioning technology, and a meeting is scheduled in the nearest available conference room.

Exemplary embodiments of the present invention include a location detection application executing on a user device. The location detection application uses indoor positioning technology to identify a physical location of a requested attendee. In addition, the location detection application can identify conference rooms that are proximate, or nearby, the requested attendee. Exemplary embodiments of the present invention also include a micro service, or application programming interface (API) communicating with a conference room scheduling application and a calendar application to find out the available time slots of the other attendee(s) and the current availability of conference rooms close to the other attendee(s). Also the meeting requestor user can schedule a meeting with other users based on the meeting requestor' s available time slot and available conference room located close to the meeting requestor.

Turning now to FIG. 1, a schematic diagram 100 of selecting meeting locations is generally shown, in accordance with an embodiment of the disclosure. The schematic diagram 100 of FIG. 1 includes user devices 106, attendees 116, beacons 110, meeting location module 102, calendar module 104, and meeting scheduler module 108. As shown in FIG. 1, beacons 110 may be located in meeting locations 114.

The user devices 106 shown in FIG. 1 implement indoor positioning technology to determine the current physical location of the user device 106 and conference rooms that are nearest to the current physical location of the user device. As shown in FIG. 1, the indoor position technology utilizes at least one beacon 110 in operable communication with each user device 106. As used herein, the term “indoor positioning technology” refers to the process of identifying the location of users and/or objects within a building. One known method that may be implemented by one or more embodiments includes putting beacons in a building, located in various areas so that at any particular location a mobile device can ‘hear’ at least some number of beacons, and that by determining the signal strength of each of the beacons the system can determine the approximate location of the device by a process called “triangulation.” Similarly, the process can be implemented by wireless network routers and using multiple wireless network access points to receive signal and determine location of the mobile device. Alternatively, the process can be reversed where the wireless network routers can hear a signal from a mobile device and based on the collective inputs of all wireless network access points the approximate location of the person can be triangulated.

In accordance with one or more embodiments of the present invention, the indoor positioning technology is implemented using the beacons 110 as access points at known locations within a building or campus (e.g., office park, school, hotel). A beacon 110 can emit Bluetooth signals which are received by a location module 112 on user devices 106 within range of the Bluetooth signal being emitted from the beacon 110. The location module 112 can determine a location of the user device 106 relative to the beacon 110 based, for example on the signal strength of the Bluetooth signal and/or on triangulation techniques. The location module 112 can determine of the user device 106 relative to a meeting location 114 based, for example on the signal strength of the Bluetooth signal from a beacon 110 located in or near the meeting location 114.

The beacons 110 can be located in enough places within the area being monitored (e.g., a building or campus) so that the position of an attendee 116 carrying a user device 106 can be tracked to within a desired granularity (e.g., five feet, ten feet, twenty feet).

The location module 112 in the user device 106 can also determine the location of the user devices 106 based on access readers located, for example on doors in a building. The access readers on the doors can emit Bluetooth signals that are detected by the location module 112. In this manner, the location module 112 can track the last door that a person opened or was near to determine the location of the user device 106.

As shown in FIG. 1, the meeting scheduler module 108 is in operable communication with the meeting location module 102, the calendar module 104, and the user devices 106. The meeting schedule module 108 receives the locations of the requested attendees 116 from the user devices 106 or directly from the beacons 110. The meeting scheduler module 108 also receives a request to schedule a meeting and requested attendees. The request for the meeting may be automatically initiated, or inferred from a process, for example, using an email and requesting a meeting as soon as possible with all of the people on the email (e.g., on the “To” and “From” fields).

In an embodiment, the request is received from a meeting requestor (who may also be one of the requested attendees 116) via a user device 106. In addition, the meeting schedule module 108 retrieves meeting location availability for the meeting locations that are determined to be closest to one or more of the attendees from the meeting location module. In addition, the meeting schedule module 108 retrieves time slots that the attendees are available from the calendar module 104. In one or more embodiments of the present invention, the meeting location module 102 and the calendar module 104 are implemented using a commercially available product for performing calendar functions such as, but not limited to Microsoft Exchange Server. Once the meeting scheduler module 108 selects a time slot (which may be, for example, “right now” or “as soon as possible”) and meeting location for the meeting, the meeting scheduler module 108 sends a request to reserve the meeting location to the meeting location module 102. In addition, the meeting scheduler module 108 can send the information to the attendees via email and/or it can send the information to the calendar module 104 to update the attendees' calendars with the meeting time and location. The information can be sent to the attendees by any office software known in the art such as, but not limited to Outlook® from Microsoft.

The user device 106 may be a computing device such as a desktop computer. The user device 106 may also be a mobile computing device that is typically carried by a person, such as, for example a phone, PDA, smart watch, tablet, laptop, etc. The user device 106 may also be two separate devices that are synced together such as, for example, a cellular phone and desktop computer synced over an internet connection.

Though not shown in FIG. 1, the user device 106 may include a processor, a memory, and a communication module for implementing one or more communication protocols as described in further detail herein. The processor may be implemented by any type or combination of computer processors, such as but not limited to a microprocessor, microcontroller, digital signal processor, application specific integrated circuit, programmable logic device, and/or field programmable gate array. The memory may be implemented by any non-transitory computer readable storage medium tangibly embodied in the user device 106 including executable instructions stored therein, for instance, as firmware.

In accordance with one or more embodiments of the present invention, the meeting location module 102, calendar module 104, and meeting scheduler module 108 are implemented by computer instructions executing on a computer. The computer may include a processor, and memory, and a communication module to implement one or more communication protocols as described further herein. The processor can be any type or combination of computer processors, such as a microprocessor, microcontroller, digital signal processor, application specific integrated circuit, programmable logic device, and/or field programmable gate array. The memory may be implemented by any non-transitory computer readable storage medium tangibly embodied in or operably connected to the path determination system including executable instructions stored therein, for instance, as firmware.

Though not shown in FIG. 1, one or more embodiments of the present invention include a building automation system with instructions to adjust environmental conditions of the meeting locations. A set point can be specified for times when the meeting location is occupied and another set point can be specified for times when the meeting location is not occupied. The set points can specify environmental conditions such as, but not limited to temperature, humidity, and/or which lights are turned on or off in the room. The set point conditions can be monitored using other sensors such as temperature sensors and humidity sensors. In an embodiment WebCTRL® Building Automation System from Automated Logic is utilized to set and monitor heating, air conditioning and lighting systems in the meeting room, using different set points depending on whether the room is occupied or unoccupied.

The user devices 106, meeting location module 102, calendar module 104, and meeting scheduler module 108 communicate with each other via any one or more known short and/or long range communication protocols. The communication may be over a wired or wireless network, such as 802.11x, short-range radio (Bluetooth), cellular, satellite, etc. In example embodiments, the communication is over multiple independent wired and/or wireless networks including, but not limited to the Internet, the world-wide-web, hyper text transfer protocol (HTTP), and HTTP secure (HTTPS). Embodiments are intended to cover a wide variety of types of communication and embodiments are not limited to the examples provided in this disclosure.

In the example embodiment shown in FIG. 1, meeting location module 102, calendar module 104, and meeting scheduler module 108 are illustrated as separate systems. Various configurations may be implemented by other embodiments. For example in an embodiment, calendar module 104 and the meeting scheduler module 108 are combined and executed in the same system, or server.

Only few user devices 106, beacons 110, and meeting locations 114 are shown in FIG. 1, however one skilled in the art will appreciate that embodiments are not limited to this number of user devices 106, beacons 110, and meeting locations 114, as typical implementations will include a much larger number.

Turning now to FIG. 2, a flow diagram 200 illustrating a method of selecting meeting locations is generally shown, in accordance with an embodiment of the disclosure. All or a subset of the processing shown in FIG. 2 may be implemented by location module 112, meeting location module 102, calendar module 104, and meeting scheduler module 108 executing on a processor. At block 202, a request to reserve a meeting location is received by a user. As a first step the user selects the attendees along with the time slot and initiates the request to reserve a meeting location. At block 204, the physical location of the requested meeting attendees is determined. The request to reserve the meeting location may specify the current day or a day in the future.

At block 206, one or more time slots that the requested meeting attendees are available are identified. As used herein, the term “time slot” refers to a specific time span such as, but not limited to 9 a.m.-10 a.m. In accordance with one or more embodiments of the present invention, the identified time slots are on the same day and within a threshold amount of time of the request to reserve a meeting location. In this manner, embodiments are used to set up impromptu/short notice meetings and there may be less chance that the requested attendees' physical location(s) will change between setting up the meeting and holding the meeting. At block 208, meeting locations that are available in the identified time slots are located. The located meeting locations may include just those that are within a threshold distance, which may be defined by a specific distance (fifty feet, one hundred feet) or by an estimated amount of travel time (e.g., five minutes, ten minutes), from one or more of the attendees. In accordance with one or more embodiments of the present invention, for meetings in the future, an expected or ‘normal’ or ‘predicted’ location of the user may be used based upon analytics of their past location or based upon their expected location based on a travel schedule.

At block 210, one of the meeting locations is selected based at least in part on a proximity (e.g., within a threshold distance) to a current physical location of at least one of the meeting attendees. For example, there may be just two requested attendees (e.g., the meeting requestor and one additional person) and the threshold distance may be measured based either on the current location of the meeting requestor or the current location of the one additional person. In another example, where there are just two requested attendees (e.g., the meeting requestor and one additional person), the meeting location may be selected to be close to a halfway point between the meeting requestor and the one additional person. In another example, when there are more than two requested attendees, the meeting location may be selected based on all or just a subset of the current locations of the requested attendees.

At block 212, the selected meeting location is reserved for the meeting. In accordance with one or more embodiments of the present invention, the requested attendees are notified of the meeting time and the meeting location via, for example, email or text message. In accordance with one or more embodiments of the present invention, an environmental set point (e.g., temperature, lighting) of the meeting location is changed during the time slot. In an embodiment, the set point is changed a threshold amount of time (e.g., five minutes, ten minutes, thirty minutes) prior to the time slot and stays set for a for a threshold amount of time after the time slot (e.g. ten minutes, thirty minutes).

In accordance with one more embodiments of the present invention, a mobile credential is sent to at least one of the requested meeting attendees (e.g., the meeting requestor) based on the meeting location being selected. The meeting credential can be set to unlock an access control device that control access to the meeting location. The access control device can be a lock on a door to a conference room. The credential may only be valid for a threshold amount of time prior to the meeting and may be invalid after the meeting. In accordance with one or more embodiments of the present invention, the credential may be in the form of a digital certificate or access control data that is used by the access control device to determine that the person is authorized to enter. The credential may be verifiable via digital signatures or the like as is well known in the art of digital credentialing for access control.

In accordance with one or more embodiments of the present invention, directions to the selected meeting location from their current physical location may be sent to one or more of the requested attendees. The directions may include a graphic such as a map and/or text instructions.

While the above description has described the flow process of FIG. 2 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes a device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

1. A method of selecting meeting locations, the method comprising:
receiving a request to schedule a meeting, the request including requested meeting attendees;
receiving a current physical location of at least a subset of the requested meeting attendees;
identifying time slots that the requested meeting attendees are available for the meeting; and
selecting a meeting location for the meeting at a time slot included in the identified time slots, the selecting based at least in part on availability of the meeting location during the time slot and a proximity of the selected meeting location to the at least a subset of the meeting attendees.

2. The method of claim 1, wherein the selecting comprises reserving the meeting location for the meeting during the time slot.

3. The method of claim 2, wherein the selecting further comprises notifying the requested meeting attendees of the meeting location and the time slot.

4. The method of claim 3, wherein a time of the notifying takes into account a travel time to the meeting location.

5. The method of claim 1, further comprising based at least in part on the selecting, changing an environmental set point of the meeting location during the time slot.

6. The method of claim 5, wherein the environmental set point includes at least one of a temperature at the meeting location and lighting at the meeting location.

7. The method of claim 1, further comprising based at least in part on the selecting, transmitting a mobile credential to at least one of the requested meeting attendees, the mobile credential configured to unlock, during the time slot, an access control device that controls access to the meeting location.

8. The method of claim 1, further comprising based on the selecting, transmitting to each of the at least a subset of the requested meeting attendees directions from their current physical locations to the selected meeting location.

9. The method of claim 1, wherein the current physical location of at least a subset of the requested meeting attendees is determined based at least in part on indoor positioning techniques.

10. The method of claim 1, wherein the current physical location of at least a subset of the requested meeting attendees is a physical location within a building.

11. The method of claim 1, wherein the time slot is within a threshold amount of time of receiving the request.

12. A system for selecting meeting locations, the system comprising:
a processor; and
a memory comprising computer-executable instructions that, when executed by the processor, cause the processor to perform operations, the operations comprising:
receiving a request to schedule a meeting, the request including requested meeting attendees;
receiving a current physical location of at least a subset of the requested meeting attendees;
identifying time slots that the requested meeting attendees are available for the meeting; and
selecting a meeting location for the meeting at a time slot included in the identified time slots, the selecting based at least in part on availability of the meeting location during the time slot and a proximity of the selected meeting location to the at least a subset of the meeting attendees.

13. The system of claim 12, wherein the selecting comprises reserving the meeting location for the meeting during the time slot.

14. The system of claim 13, wherein the selecting further comprises notifying the requested meeting attendees of the meeting location and the time slot.

15. The system of claim 12, wherein the operations further comprise, based at least in part on the selecting, changing an environmental set point of the meeting location during the time slot.

16. The system of claim 15, wherein the environmental set point includes at least one of a temperature at the meeting location and lighting at the meeting location.

17. The system of claim 12, wherein the operations further comprise, based at least in part on the selecting, transmitting a mobile credential to at least one of the requested meeting attendees, the mobile credential configured to unlock, during the time slot, an access control device that controls access to the meeting location.

18. The system of claim 12, wherein the operations further comprise, based on the selecting, transmitting to each of the at least a subset of the requested meeting attendees directions from their current physical locations to the selected meeting location.

19. The system of claim 12, wherein the current physical location of at least a subset of the requested meeting attendees is determined based at least in part on indoor positioning techniques.

20. The system of claim 12, wherein the time slot is within a threshold amount of time of receiving the request.
